(19) United States
(12) Patent Application Publication
(10) Pub. No.: US 2015/0162870 A1
(43) Pub. Date: Jun. 11, 2015

(54) Edge Connector for Photovoltaic Solar Modules

(71) Applicant: Phoenix Contact GmbH & Co. KG, Blomberg (DE)

(72) Inventors: Andreas Beck, Polle (DE); Mehmet Sagdic, Detmold (DE)

(21) Appl. No.: 14/413,039

(22) PCT Filed: Jul. 11, 2013
(86) PCT No.: PCT/EP2013/064730

§ 371 Date: Jan. 6, 2015

(30) Foreign Application Priority Data
Jul. 11, 2012 (DE) 10 2012 106 241.2

(51) Int. Cl. H02S 40/36; H01R 13/52; H01R 13/58; H01R 31/06

(52) U.S. Cl. CPC H02S 40/36; H01R 31/06; H01R 13/52; H01R 13/5845

(57) ABSTRACT

An edge connector for a photovoltaic solar module is provided, comprising: a dielectric edge connector housing with a lateral mounting tab for attachment to an end-face edge of the solar module; a first cable connector disposed at an end of the edge connector housing for releasably connecting a first connection line to the edge connector for establishing an electrical connection between the connection line and the solar module; a second cable connector disposed opposite the first cable connector on the edge connector housing and electrically connected to the first cable connector, for attaching an edge connector line that is limited to the solar module; and a conductor strip connecting element disposed between the cable connectors of the edge connector and electrically connected to the cable connectors, for electrical connection to a conductor strip.

### TECHNICAL FIELD

The present disclosure relates to an edge connector for a photovoltaic solar module.

### BACKGROUND

Photovoltaic solar modules are meanwhile available on the market in various configurations. Besides the most commonly used framed glass-film modules for roof mounting or open-space mounting, those configured in form of tiles and applicable in particular for being integrated in buildings as facade or roof elements are of particular interest.

Such a tile- or plate-shaped solar module typically comprises a sandwich-like multilayered configuration including a front light-transmitting cover layer facing the light source (sun), a rear cover plate, solar cells arranged in an intermediate space for generating electrical energy from sunlight, and an outer frame on an end-face edge of the solar module circumferentially connecting the cover layer and the cover plate tightly to one another.

For electrically contacting the solar cells to connection lines and/or other solar modules, conductor strips that are limited to the module typically extend laterally outwards from the intermediate space or extend into the proximity of the end-face edge, so that they can be connected to a respective edge connector.

In order to avoid damage of the solar modules caused by reverse currents, so-called hot spots, that may in particular occur when individual solar modules of a photovoltaic generator are shaded or partially shaded, it is known especially for the framed glass-film modules as well as for glass-film modules to use bypass diodes and/or string diodes, i.e., more generally, reverse current diodes which have a forward and a reverse direction in terms of current flow. In this case, the bypass diodes are typically accommodated in the terminal and junction box mounted on the rear face. Due to the desired smallest possible spacing between the plurality of solar modules, however, such a circuit cannot readily be accommodated within an edge connector.

### GENERAL DESCRIPTION

The present disclosure is based on the object to provide an edge connector which is compact in size and can be installed easily.

Another object of the present disclosure is to provide a photovoltaic solar module with two edge connectors, which edge connectors can be interconnected via an edge connector line.

The object of the present disclosure is achieved by the subject matter of the independent claims. Advantageous modifications of the present disclosure are defined in the dependent claims.

According to the present disclosure, an edge connector comprises a dielectric edge connector housing with a lateral mounting tab. By means of the mounting tab, the edge connector can be attached to an end-face edge of the solar module. Preferably, the edge connector is attached laterally to the solar module, in the region of the outer frame, by directly gluing the lateral mounting tab into the laminate of the solar module during the lamination process, or by inserting and gluing the lateral mounting tab into a gap, a slit, or an opening of the outer frame, in particular between the front cover layer and the rear cover plate. However, even in a solar module without an outer frame, such as in particular in a frameless glass-glass module, the edge connector can be attached to the end-face edge of the solar module by directly gluing the lateral mounting tab into the laminate of the solar module during the lamination process, or by inserting the lateral mounting tab into the gap in the end-face edge between the front cover layer and the rear cover plate of the solar module. The attachment to a frameless glass-glass module is preferred for mounting the edge connector, since in this case there is no outer frame which first has to be prepared for the installation of the edge connector.

The edge connector has a dielectric edge connector housing which accommodates the electrically conductive components of the edge connector and at the same time has a lateral mounting tab for attaching the edge connector to the solar module. The edge connector housing may be fabricated in one piece or in several pieces and/or in an injection molding process.

A first cable connector is disposed at an end of the edge connector for releasably connecting the connection line to the edge connector, by means of which an electrical connection can be established between the connection line and the solar module.

A second cable connector is disposed opposite the first cable connector on the edge connector and is electrically connected to the first cable connector. The second cable connector can be connected with an edge connector line limited to the solar module, or with a second connection line.

The arrangement of the first and second cable connectors opposite each other, in particular on the opposite end faces of the edge connector, provides for a configuration of the edge connector that is space-saving and as compact as possible.

A conductor strip connecting element is disposed between the first and the second cable connector and is electrically connected to the first and second cable connector. The conductor strip connecting element establishes the electrical connection between the edge connector and the solar cells of the solar module.

On the module side, the solar module may have contact regions, each of which can be connected to a conductor strip connected to the edge connector. In other words, a pre-assembled edge connector which has a conductor strip that is already connected to the conductor strip connecting element before its installation in the solar module can be attached directly to the solar module, in particular during the lamination process. Such a pre-assembled edge connector is particularly preferred in case of an overmolded edge connector.

Alternatively, it is also possible for the edge connector to be connected to a conductor strip protruding from the solar module directly during installation.

The edge connector has a compact configuration, such that after having been mounted to a solar module essentially only a cylindrical or rod-shaped portion of the edge connector, which comprises the first and the second cable connector and the conductor strip connecting element directly extend from the solar module. Accordingly, the connector housing comprises the elongated portion axially aligned to the end face of the solar module, and the laterally arranged mounting tab which extends into the solar module in its mounted state. In this manner, the installation area required for the electrical installations can be reduced to a minimum and thus a larger number of solar modules can be installed in a predetermined area.

In addition, such a compact edge connector reduces the risk that the edge connector is broken off, i.e. destroyed, by improper handling. Not least, the compact geometry of the edge connector moreover reduces the production costs, since the edge connector housing can be further downsized as compared to the prior art.

Another beneficial impact on production processes is provided by the rounded, edgeless geometry of the edge connector that is preferably chosen, which geometry protects the laminator membranes in the lamination process even when solar modules are employed, that are thinner than the size of the edge connector, which may be obtained in particular by using thinner glasses.

The conductor strip connecting element of the edge connector preferably comprises an electrically conductive sleeve, e.g. a metal sleeve. The electrically conductive sleeve of the conductor strip connecting element preferably directly electrically interconnects the first and the second cable connector arranged opposite each other, so that no further electrical components need to be arranged between the cable connectors and the conductor strip connecting element. The electrically conductive sleeve therefore extends within the edge connector housing from the first cable connector to the second cable connector, preferably in a direction aligned along one edge of the photovoltaic solar module, thus directly connecting the first cable connector of the edge connector with the second cable connector of the same edge connector. This can further reduce the production costs.

Preferably, the conductor strip protruding from the solar module or protruding from the edge connector into the solar module is electrically connected to the electrically conductive sleeve. For connecting the conductor strip to the electrically conductive sleeve, in one embodiment the conductor strip is wrapped around the sleeve and is preferably welded to the sleeve.

In other words, a continuous metal sleeve may be arranged in the edge connector housing which directly electrically connects exactly one conductor strip of the photovoltaic solar module with both the first cable connector and the second cable connector, without requiring any further electrical components such as in particular semiconductor components in the edge connector. Thus, by means of this metal conductor strip connecting element the edge connector connects exactly one and not both of the electric poles of the photovoltaic solar module with the cable connectors of the edge connector.

Preferably, the first and second cable connectors are configured so as to be distinguishable from each other, so that incorrect connection and/or polarity reversal of wires can be avoided. A distinguishable design may comprise two configurations that are mateable with each other, or several configurations, if a higher degree of distinguish ability of the cable connectors is desired.

In one embodiment of the present disclosure, the first and second cable connectors have a contact point in the interior of a touch protection sleeve for making electrical contact with a line to be connected, in particular the connection line and/or the edge connector line. Therefore, the contact point can have a touch-proof design because it is accommodated in the touch protection sleeve.

Furthermore, the touch protection sleeve may have a sealing element, so that the contact point is designed to be watertight in the connected state of the cable connector.

Preferably, the first and/or second cable connectors are plug-in connectors. In this case, the lines to be connected thereto, e.g. the connection line or the edge connector line, have plug-in connectors mateable therewith.

To increase the adhesive strength of the lamination compound or sealant used for mounting the edge connector, the mounting tab of the edge connector may have perforations or openings, so that the surface of the mounting tab does not form a closed surface and the intermediate spaces in the openings of the mounting tab can be filled with lamination compound or sealant, whereby the front cover layer and the rear cover plate are bonded to each other even in the region of the mounting tab. Preferably, the same lamination or sealing material which is used for joining the front cover layer and the rear cover layer is used for glue bonding the edge connector. In particular, the edge connector is adhesively connected to the solar module during the lamination process of the solar module, so that an additional work step can be eliminated during the mounting of the edge connector.

A photovoltaic solar module of the present disclosure for generating electrical power from sunlight comprises a first and a second edge connector mounted to the solar module, for connecting a first and second electrical string connector line to the solar module.

The edge connectors of the solar module each have a dielectric edge connector housing with a lateral mounting tab, so that the edge connectors can be attached to an end-face edge of the solar module. Preferably, both edge connectors are arranged on the same side of the solar module.

In other words, two spaced apart edge connectors are arranged on the photovoltaic solar module, each with a separate edge connector housing, so that an electric pole of the photovoltaic solar module can be connected to each of the edge connectors. Thus, the two edge connectors of the photovoltaic solar module are single pole connectors.

Each edge connector of the solar module comprises a first cable connector for connecting the first or the second string connection line to the solar module, each first cable connector being mounted at an end of the edge connector. A respective second cable connector is mounted to the edge connector opposite the respective first cable connector and is electrically connected to the respective first cable connector. Each of the second cable connectors allows to attach an edge connector line limited to the solar module. Between the first and second cable connectors of the respective edge connector, a conductor strip connecting element is arranged for electrical connection to a respective conductor strip which protrudes from the solar module or is already pre-assembled to the conductor strip connecting element.

In one illustrative embodiment, the edge connector line of the solar module includes a bypass diode and is connected to the respective second cable connectors of the edge connectors, so that the solar module can be electrically bypassed through the edge connector line in case of a failure such as caused by shading, or generally in case of reverse currents. The arrangement of the bypass diode in the edge connector line may be desirable because the edge connector line is easily replaceable in case of a failure of the bypass diode. Furthermore, the edge connector line with the bypass diode can be dispensed with when it is expected that the solar module fused by the bypass diode will not be affected by disturbances, such as in particular shading. In other words, the bypass diode is arranged outside the edge connector housing and forms part of the edge connector line.

The present disclosure furthermore provides a system comprising a plurality of solar modules to forma photovoltaic generator, wherein the solar modules comprise a first and a second edge connector for connecting a first and a second string connection line to the respective solar module. The first and second edge connectors are preferably attached to the surrounding frame of the respective solar module.

The edge connectors of the respective solar module have a dielectric edge connector housing with a lateral mounting tab, so that the edge connectors are attachable to an end-face edge of the solar module. Preferably, both edge connectors are arranged on the same end-face edge of the solar module.

Each edge connector of the solar module comprises a first cable connector for connecting the first or second string connection line to the solar module, which first cable connector is mounted at an end of the edge connector. A second cable connector is mounted to the edge connector opposite the first cable connector and is electrically connected to the first cable connector. The second cable connector enables to attach an edge connector line limited to the solar module. Between the first and the second cable connector of the edge connector, a conductor strip connecting element is arranged for electrical connection to the conductor strip.

Each solar module of the system that comprises a plurality of solar modules may be equipped with an edge connector line including a bypass diode. Accordingly, the respective second cable connector of the edge connectors of a solar module is adapted for being connected to the releasable edge connector line, so that the respective solar module can be electrically bypassed through the edge connector line in case of a failure, or generally in case of reverse currents. Preferably, at least part of the solar modules in the system of a plurality of solar modules is equipped with the edge connector line, in particular the part in which shading has to be expected. Thus, the usually expensive bypass diodes can be omitted in the modules in which they are unlikely to be needed. If, however, in contrast to what was planned, they are required at a later time, or if they have to be replaced in case of a failure, this can be done easily and quickly. This is facilitated by releasably connecting the edge connector line including the bypass diode to the respective second cable connector of the edge connector of a solar module thus becoming a part of the respective solar module.

The present disclosure will now be explained in more detail by way of illustrative embodiments and with reference to the figures in which identical and similar elements are partly designated with the same reference numerals, and wherein the features of the various illustrative embodiments can be combined with each other.

### BRIEF DESCRIPTION OF THE FIGURES

In the drawings:

FIG. 1 is a top view of an edge connector for attachment to a solar module;

FIG. 2 is an end view of an edge connector according to FIG. 1;

FIG. 3 is a longitudinal side view of an edge connector according to FIG. 1;

FIG. 4 is another end view of an edge connector according to FIG. 1;

FIG. 5 is another longitudinal side view of an edge connector according to FIG. 1;

FIG. 6 is another top view of an edge connector according to FIG. 1;

FIG. 7 is a top view of an edge connector attached to a solar module;

FIG. 8 is an end view of an edge connector attached to a solar module;

FIG. 9 is a top view of an edge connector according to FIG. 1 without edge connector housing;

FIG. 10 is an end view of an edge connector according to FIG. 9;

FIG. 11 is a top view of a photovoltaic solar module with two edge connectors attached to the solar module;

FIG. 12 shows an embodiment of an edge connector line;

FIG. 13 is a top view of a photovoltaic solar module according to FIG. 5, with an edge connector line additionally inserted between the edge connectors; and

FIG. 14 is a side view of a photovoltaic solar module according to FIG. 7.

### DETAILED DESCRIPTION OF THE FIGURES

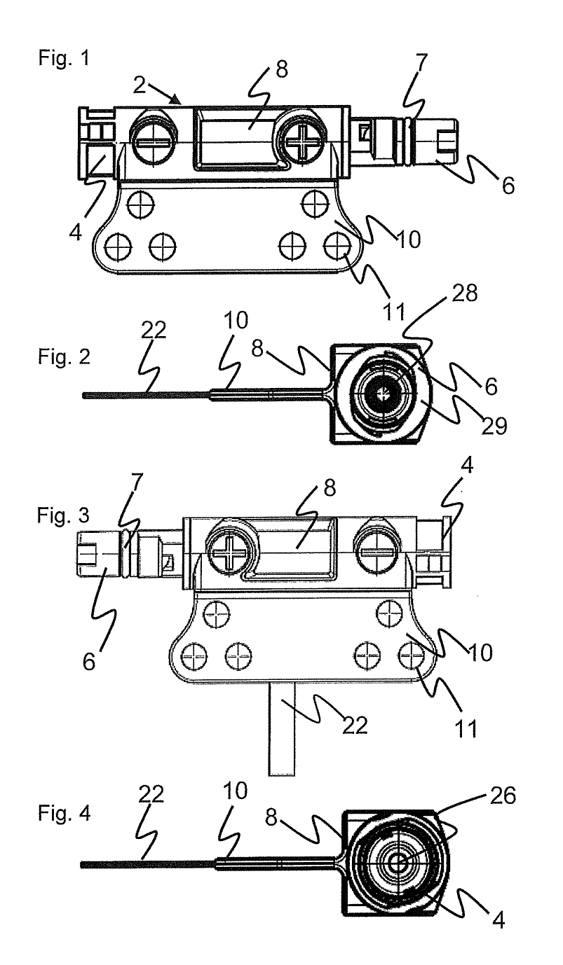

FIG. 1 shows an edge connector 2 of the present disclosure for attachment to a photovoltaic solar module, which includes a first cable connector 4, a second cable connector 6, and an edge connector housing 8 with amounting tab 10. Edge connector 2 can be attached to solar module 16 by means of mounting tab 10 which can be inserted into an end-face edge 14 (see FIG. 8) of a solar module 16. In particular, mounting tab 10 is formed in one piece and has bulges at the edges, which extend further into the laminate of the solar module without having a larger entry area in the solar module. Mounting tab 10 can be glue bonded to solar module 16 in the interior thereof, and bores 11 are provided in mounting tab 10 for increasing adhesion. In the illustrated embodiment, the part of edge connector 2, which protrudes from solar module 16 is elongated or rod-shaped and/or rounded or without edges. The part of edge connector 2 protruding from solar module 16 has two end faces on which the first cable connector 4 and the second cable connector 6, respectively, are arranged in this embodiment, and has two lateral sides extending in parallel to the end-face edge of solar module 16, with mounting tab 10 arranged on one of the lateral sides.

For example, a first connection line 24a or a generator string line 24b may be connected to first cable connector 4. Second cable connector 6 may be used for connecting an edge connector line 12 (see FIG. 12) or a generator string line 24b, wherein the edge connector line 12 may comprise a bypass diode 32. In the illustrated embodiment, second cable connector 6 comprises an elongated touch protection sleeve 29 which surrounds and accommodates the cable terminal, so that the latter can not or only hardly be touched even in its non-inserted state. In the illustrated example, a sealing ring 7 is arranged centrally on the outer surface of touch protection sleeve 29 of second cable connector 6, water-tightly sealing the cable terminal in the inserted state and therefore protecting the cable connector from ingress of dust, dirt and water. In the illustrated embodiment, the first terminal (26, see FIG. 4) of first cable connector 4 is a male cable connector, i.e. a plug, and the second terminal (28, see FIG. 2) of second cable connector 6 is a female cable connector, i.e. a socket.

First cable connector 4 is arranged opposite to second cable connector 6, in particular opposite with axial alignment, as shown in FIG. 1. In their mounted state, therefore, first cable connector 4 and second cable connector 6 are arranged adjacent to each other in parallel to the end-face edge of solar module 16, on which the edge connector 2 is attached to the solar module. First cable connector 4 and second cable connector 6 are preferably rectilinear and extend along an axis in parallel to the end-face edge of the solar module.

In addition, the compactness of the configuration of the edge connector 2 according to the present disclosure can be further increased by having bypass diode 32 arranged outside edge connector housing 8. Besides the small size, such an arrangement of bypass diode 32 outside edge connector housing 8 provides for exchangeability of bypass diode 32 in a maintenance case.

FIG. 2 is an end view of an edge connector 2 according to FIG. 1, in which the second terminal 28 accommodated by second cable connector 6 is visible. Second terminal 28 is accommodated in a touch protection sleeve 29 and is designed as a male terminal. On one lateral side of edge connector housing 8, mounting tab 10 is provided.

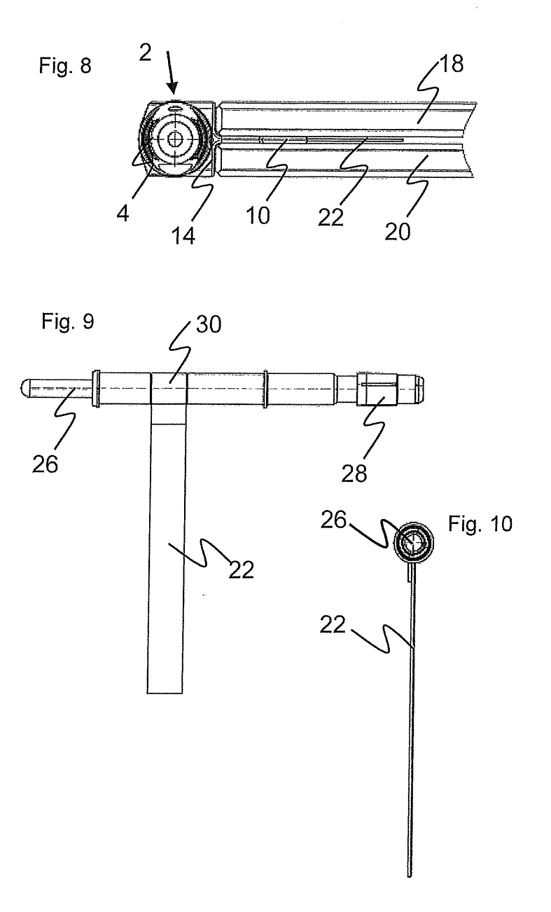

The embodiment of edge connector 2 according to FIG. 2 shows an edge connector housing 8 overmolded around the electrical parts of edge connector 2, and with conductor strip 22 already pre-assembled and connected to conductor strip connecting element 30 (see FIG. 9) and partly surrounded by the injection molding material. In other words, the edge connector housing 8 is formed by overmolding the electrically conductive parts of edge connector 2.

In case of an overmolded edge connector housing 8, only a portion of conductor strip 22 provided for connection to solar module 16 may protrude from edge connector housing 8, namely from mounting tab 10 in this example. The overmolding process allows the edge connector housing 8 to be fabricated particularly efficiently and watertight.

FIG. 3 shows a further longitudinal side view of an edge connector 2, in which the edge connector includes an injection molded edge connector housing 8 and accordingly conductor strip 22 is part of the pre-assembled edge connector 2.

FIG. 4 shows an end view of an edge connector 2 according to FIG. 1, in which the first terminal 26 accommodated by cable connector 4 is visible. First terminal 26 is designed as a female terminal. On one lateral side of edge connector housing 8, mounting tab 10 is provided. Similar to FIG. 2, the embodiment illustrated in FIG. 4 shows an injection molded edge connector housing 8 in which the conductor strip 22 is pre-assembled and connected to conductor strip connecting element 30 and is a part of edge connector 2.

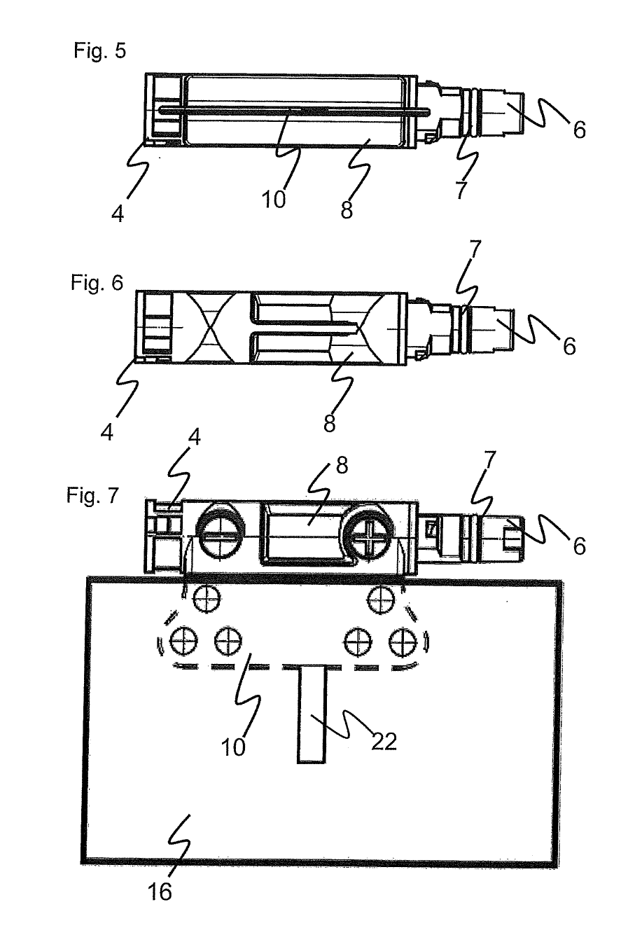

FIG. 5 is a further longitudinal side view of an edge connector 2 according to FIG. 1, illustrating mounting tab 10 and the side of edge connector housing 8 which is inserted into solar module 16.

FIG. 6 is a top view of an edge connector 2 according to FIG. 1, with first cable connector 4, second cable connector 6, sealing ring 7, and edge connector housing 8.

FIG. 7 shows an edge connector 2 corresponding to FIG. 1 attached to an end-face edge 14 of a photovoltaic solar module 16. Mounting tab 10 of edge connector 2 is inserted between front cover layer 18 (see FIG. 8) and rear cover plate 20 (see FIG. 8) of solar module 16, so that it can not be seen in a top view, or as the case may be through a glass surface.

A conductor strip 22 of solar module 16 extends laterally out of solar module 16 and is attached to edge connector 2. In case of a pre-assembled edge connector 2, the conductor strip 22 is already part of edge connector 2 and is attached to the solar module together with edge connector 2, in particular it is connected to contact areas of the solar module. For this purpose, the conductor strip 22 of pre-assembled edge connector 2 is contacted, e.g. welded or soldered, to a conductor path or flexible flat conductor strip of solar module 16 during the lamination process of solar module 16.

In order to improve the adhesive strength of the edge connector, bores are introduced in mounting tab 10, which allow for a direct contact of the lamination compound or sealant provided on front cover layer 18 with that provided on rear cover plate 20.

FIG. 8 shows a side view of edge connector 2 attached to solar module 16 between front cover layer 18 and rear cover plate 20, with the conductor strip 22 protruding from solar module 16 between layers 18, 20 wrapped or laid and/or welded around an electrically conductive sleeve 24 of edge connector 2. The electrically conductive sleeve 24 extends within edge connector housing 8 between the first and second plug-in terminal element 26, 28. The solar cells of solar module 16 are also arranged between layers 18, 20, so that they are protected from environmental influences. Edge connector 2 may have a thickness so as to be substantially just adapted to the thickness of solar module 16 by only slightly exceeding or even being smaller than the latter. In this manner, an additional installation height only for the electrical installation of solar modules 16 can be avoided.

FIG. 9 shows a top view of one embodiment of an edge connector 2, wherein dielectric edge connector housing 8 is omitted for a better overview. A first terminal 26 arranged in first cable connector 4 makes the electrical contact between edge connector 2 and a first connection line 24a or a generator string line 24b. A second terminal 28 arranged in second cable connector 6 optionally makes the contact to an edge connector line 12. The conductor strip connecting element 30 arranged between first terminal 26 and second terminal 28 establishes an electrical contact between edge connector 2 and conductor strip 22 and therefore also an electrical contact between first connection line 24a or generator string line 24b and solar module 16.

Therefore, first terminal 26 is preferably arranged axially opposite to second terminal 28 of cable connector 2, with the conductor strip connecting element 30 arranged between first terminal 26 and second terminal 28. For this purpose, conductor strip 22 protrudes from solar module 16 perpendicular to the end-face edge of solar module 16, and as shown in FIG. 9 preferably also perpendicular to the axis which is formed by first terminal 26 and second terminal 28, and is attached to conductor strip connecting element 30, i.e., in particular wrapped, laid around and/or welded thereto.

In other words, edge connector 2 illustrated in the embodiments is a single-pole edge connector 2 which contacts one electric pole of the solar module. The electrically conductive parts 26, 28, 30 of edge connector 2 may therefore be punched and/or formed in one piece. In case that an injection molded edge connector housing 8 (e.g. FIGS. 2 and 4) is to be used, the edge connector 2 according to FIG. 9 in particular shows the complete part of the edge connector, which is to be enclosed by the molding material.

FIG. 10 is an end view of an edge connector 2 according to FIG. 9 illustrating the compactness of edge connector 2, in particular in the direction that corresponds to the thickness of the solar module.

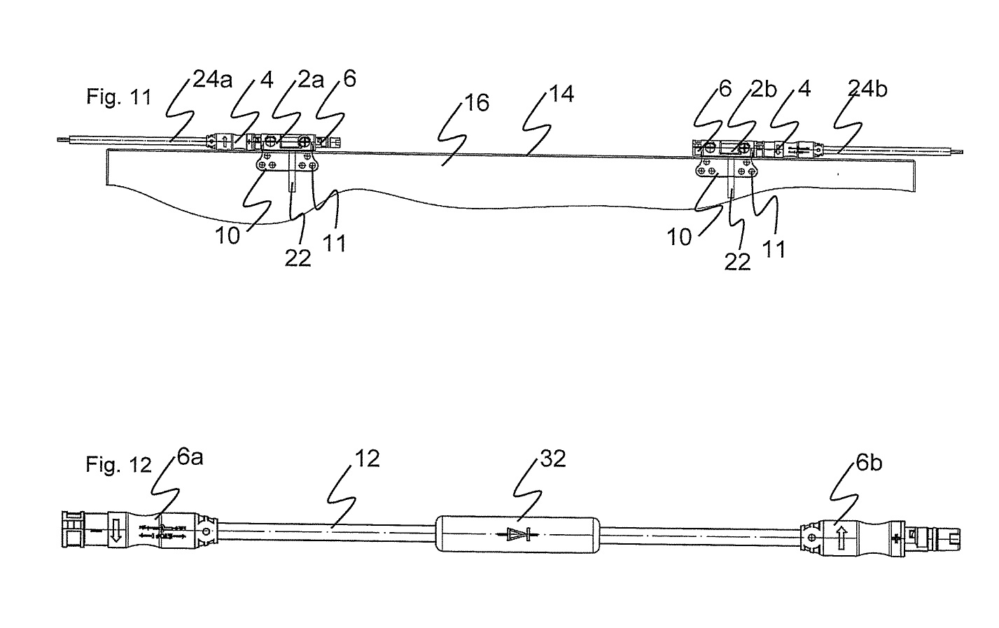

FIG. 11 is a top view of an embodiment of a photovoltaic solar module 16 with a first edge connector 2a and a second edge connector 2b, which are arranged on an end-face edge 14 of solar module 16. The attachment of edge connectors 2a, 2b to solar module 16 is accomplished by gluing mounting tab 10 of edge connector housing 8 between front cover layer 18 and rear cover plate 20. In order to improve the adhesive strength of edge connector 2 to solar module 16, bores 11 are provided in mounting tab 10, as shown in FIGS. 1, 2 above, which enable a direct contact of the lamination compound or sealant provided on front cover layer 18 with that provided on rear cover plate 20. First string line 24a is connected to the first cable connector 4 of first edge connector 2a and contacts first terminal 26 of first edge connector 2a. A second string line 24c is connected to the first cable connector 4 of second edge connector 2b.

Solar module 16 has two conductor strips 22, each edge connector 2a, 2b contacting one conductor strip 22. This ensures that each of first connection line 24a and second connection line 24c only contact one conductor strip 22 of solar module 16, so that there is always a current flow through solar module 16. Thus, edge connectors 2a, 2b are single pole edge connectors. A reverse current diode is shown in the embodiment of FIG. 6.

FIG. 12 shows an edge connector line 12 for connecting the second cable connector 6 of first edge connector 2a to the second cable connector 6 of second edge connector 2b, which edge connector line comprises a reverse current diode 32, so that in case of a failure or reverse current, solar module 16 can be electrically bypassed through reverse current diode 32 of edge connector line 12. Edge connector line 12 is connected to the respective second cable connector 6 of edge connectors 2a, 2b by means of line connectors 6a, 6b. By integrating bypass diode 32 into the circuit of solar module 16, damages to this solar module 16 can be prevented when reverse currents occur. However, if the occurrence of reverse currents can be excluded in the solar module, in some solar modules, or in all solar modules when planning the solar module installation or when planning a photovoltaic generator, the edge connector line 12 may be omitted. Moreover, edge connector line 12 may provide for a cost-efficient replacement of a defective reverse current diode.

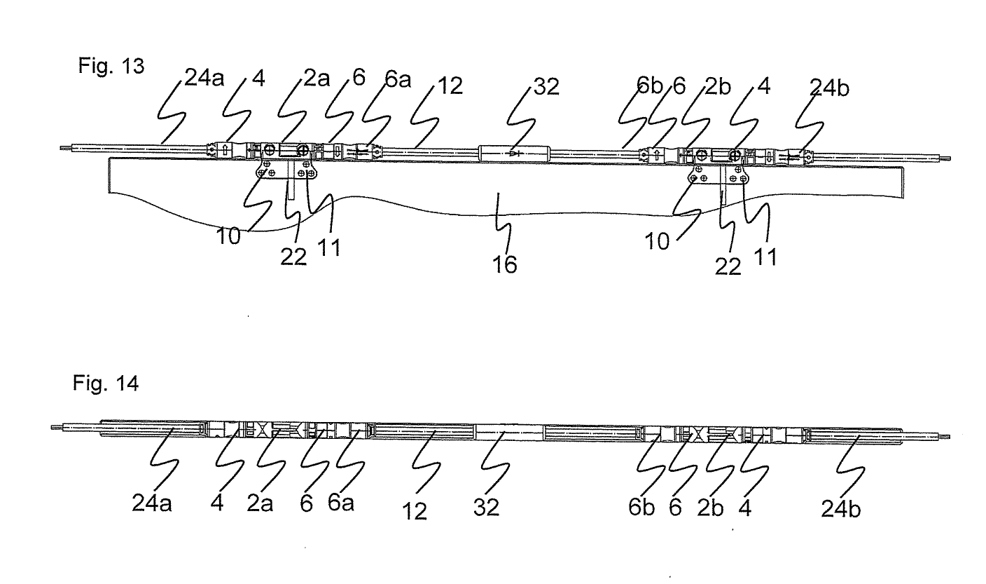

FIG. 13 shows the edge connector line according to FIG. 12 inserted into the configuration according to FIG. 11. Thus, a first edge connector 2a and a second edge connector 2b are attached to an end-face edge 14 of solar module 16 by means of a lateral mounting tab 10 which is glued between front cover layer 18 (see FIG. 8) and rear cover plate 20 (see FIG. 8) of solar module 16 at the location at which the respective conductor strip 22 protrudes from the solar module or at which conductor strip 22 is to be connected in case of a pre-assembled edge connector. In other words, edge connector housing 8 of first and second edge connectors 2a, 2b is inserted laterally, with mounting tab 10, into solar module 16 or is arranged laterally on the side of solar module 16. Conductor strip 22 is wrapped and welded around conductor strip connecting element 30 of the respective edge connector 2a, 2b, so that each of edge connectors 2a, 2b electrically contacts an electric pole of solar module 16. First connection line 24a is connected to the first cable connector 4 of first edge connector 2a, and second connection line 24c is connected to the first cable connector 4 of second edge connector 2b. Edge connector line 12 is connected to the second cable connector 6 of first edge connector 2a on the one side, and on the other side to the second cable connector 6 of second edge connector 2b.

Here, the conductor strip connecting element 30 is an electrical conductor which continuously extends within edge connector housing 8 from the first 4 to the second 6 cable connector and has a first and second plug-in terminal element 26, 28 for the first and second cable connectors 4, 6 at its two end faces. Thus, by means of the first plug-in terminal element 26, the first connection line 24a can be mated with the first cable connector 4, a reverse current diode 32 is optionally connectable to edge connector 2 outside of edge connector housing 8 and as part of the edge connector line 12. Therefore, the reverse current diode is replaceable in case of failure, since edge connector line 12 provided with the reverse current diode 32 is attachable to the second cable connector 6 by means of second plug-in terminal element 28.

The illustrated electrical link consisting of connection lines 24a, 24b, first and second edge connectors 2a, 2b, and edge connector line 12 does not extend beyond the thickness of solar module 16 in the illustrated embodiment, so that the installation height does not need to be increased beyond the dimension of solar module 16. Furthermore, it is not required for the installation to unnecessarily enlarge the installation space of a solar module 16, because in particular due to the compact configuration of first and second edge connectors 2a, 2b only the space corresponding to the width of the cable connectors need to be provided additionally, optionally plus another width necessary for easy handling of the cable connectors, which can be reduced to a minimum.

FIG. 14 finally shows a further, sectional view of two edge connectors 2a, 2b attached to an end-face edge of solar module 16, which view is rotated by 90° with respect to FIG. 13. By means of the components according to the present disclosure, in particular edge connectors 2a, 2b and the cable ends of connection lines 24a, 24c mounted thereto and edge connector line 12, the entire electrical installation can be reduced to a size smaller than or equal to the thickness of the solar module, so that the required overall installation height may be further reduced.

It will be apparent to those skilled in the art that the embodiments described above are intended as examples and that the invention is not limited thereto, but may be varied in many ways without departing from the invention. Furthermore, it will be apparent that the features also define individually essential components of the present disclosure, irrespective of whether they are disclosed in the description, the claims, the figures, or otherwise, even if they are described together with other features.

### LIST OF REFERENCE NUMERALS

2 Edge connector
2a First edge connector
2b Second edge connector
4 First cable connector
6 Second cable connector
6a, 6b Line connector of edge connector line
7 Sealing ring
8 Edge connector housing
10 Mounting tab
11 Bore
12 Edge connector line
14 End-face edge of a photovoltaic solar module
16 Photovoltaic solar module
18 Front cover layer
20 Rear cover plate
22 Conductor strip
24a First connection line
24b Generator string line
24c Second connection line
26 First terminal of first cable connector
28 Second terminal of second cable connector
29 Touch protection sleeve
30 Conductor strip connecting element
3 Reverse current diode, or bypass diode

1. An edge connector for a photovoltaic solar module, comprising:
a dielectric edge connector housing with a lateral mounting tab for attachment to an end-face edge of the solar module;
a first cable connector disposed at an end of the edge connector housing, for releasably connecting a first connection line to the edge connector for establishing an electrical connection between the first connection line and the solar module;
a second cable connector disposed opposite the first cable connector on the edge connector housing and electrically connected to the first cable connector, for attaching an edge connector line;
a conductor strip connecting element disposed between the first and second cable connectors of the edge connector and electrically connected to the first and second cable connectors, for electrical connection to a conductor strip.

2. The edge connector as claimed in claim 1, wherein the conductor strip connecting element comprises an electrically conductive sleeve which directly electrically interconnects the first and second cable connectors arranged opposite each other.

3. The edge connector as claimed in claim 2, wherein the conductor strip is wrapped around and/or welded to the electrically conductive sleeve of the conductor strip connecting element.

4. The edge connector as claimed in claim 1,
wherein the first and the second cable connectors are distinguishable from each other in their design so as to be reverse polarity protected.

5. The edge connector as claimed in claim 1,
wherein the first and the second cable connectors each comprise a touch protection sleeve, and wherein the dielectric edge connector housing has a touch-proof design.

6. The edge connector as claimed in claim 1,
wherein the cable connectors comprise a sealing element and wherein the dielectric edge connector housing has a watertight design.

7. The edge connector as claimed in claim 1,
wherein the cable connectors are plug-in connectors.

8. The edge connector as claimed in claim 1,
wherein the mounting tab of the edge connector is adapted to be inserted and glued into a slit in the end-face edge of the solar module; or
wherein the mounting tab of the edge connector is adapted to be glued into the laminate of the solar module in the lamination process.

9. The edge connector as claimed in claim 1,
wherein the mounting tab has openings for improving glue adhesion to the solar module.

10. The edge connector as claimed in claim 1,
wherein the electrically conductive parts of the edge connector are overmolded by the edge connector housing; and
wherein the conductor strip is partially overmolded by the edge connector housing.

11. A photovoltaic solar module for generating electrical power from sunlight, comprising:
a first one of the edge connector as claimed in claim 1, and a second one of the edge connector as claimed in claim 1,
wherein the first and second edge connectors are attached to the solar module for connecting a first and a second electrical string connection line;
wherein the edge connectors each comprise a dielectric edge connector housing with a lateral mounting tab for attachment to an end-face edge of the solar module, a first cable connector disposed at an end of the edge connector housing, for releasably connecting the first and second connection line to the first and second edge connector, respectively, a second cable connector mounted opposite the first cable connector on the edge connector housing and electrically connected to the first cable connector, for attaching an edge connector line, and a conductor strip connecting element mounted between the cable connectors of the edge connector, for electrical connection to a conductor strip; and
an edge connector line releasably connectable to the second cable connector of the first edge connector and to the second cable connector of the second edge connector, for electrically interconnecting the edge connectors thereby electrically bypassing the solar module.

12. The solar module as claimed in claim 11,
wherein the replaceable edge connector line comprises a reverse current diode, so that the latter can be easily replaced in case of a failure and/or can be omitted when shading of the solar module is not expected.

13. A photovoltaic generator including a plurality of photovoltaic solar modules, comprising:
at least one photovoltaic solar module for generating electrical power from sunlight; and
at least two instances of the edge connector claimed in claim 1, wherein the edge connectors are attached to the solar module for connecting a first and a second electrical string connection line of the photovoltaic generator to the solar module;
wherein the edge connectors each comprise a dielectric edge connector housing with a mounting tab for lateral attachment to the solar module, a first cable connector mounted at an end of the edge connector housing for connecting the first or second string connection line to the solar module, a second cable connector mounted opposite the first cable connector on the edge connector housing and electrically connected to the first cable connector, for attaching an edge connector line, and a conductor strip connecting element directly mounted between the first and the second cable connector of the edge connector, for electrical connection to a conductor strip;
wherein in a part of the photovoltaic solar modules, —the first and second edge connectors are interconnected via an edge connector line thereby electrically bypassing the solar module.

14. The photovoltaic generator as claimed in claim 13,
wherein the edge connector line includes a reverse current diode.
